(19) United States
(12) Patent Application Publication
(10) Pub. No.: US 2013/0246001 A1
(43) Pub. Date: Sep. 19, 2013

(54) DEVICE MONITORING SYSTEM AND METHOD

(71) Applicant: FUJITSU LIMITED, Kawasaki-shi (JP)

(72) Inventor: Hirohisa UCHIDA, Kawasaki (JP)

(73) Assignee: Fujitsu Limited, Kawasaki-shi (JP)

(21) Appl. No.: 13/869,100

(22) Filed: Apr. 24, 2013

Related U.S. Application Data
(63) Continuation of application No. PCT/JP2010/069303, filed on Oct. 29, 2010.

(51) Int. Cl. G06F 11/34

(52) U.S. Cl. CPC G06F 11/34
USPC 702/182

(57) ABSTRACT

A device monitoring system monitors a device by changing the frequency of monitoring according to the status of a device to be monitored. A device monitoring system includes a memory that stores a status of a plurality of monitoring items for each device to be monitored; and a processor detects a change in the status of monitoring items stored in the memory, and to define a status monitoring frequency of acquisition of the status of monitoring items from the device to be monitored, according to the detected change in status, and acquires the status of monitoring items from the device to be monitored according to the status monitoring frequency, and to store the acquired status of the monitoring items.

### CROSS-REFERENCE TO RELATED APPLICATION

This application is a continuation application of International Application PCT/JP2010/069303 filed on Oct. 29, 2010 and designated the U.S., the entire contents of which are incorporated herein by reference.

### FIELD

The embodiments discussed herein are related to a device monitoring system, and a device monitoring method.

### BACKGROUND

A device monitoring system includes a plurality of devices as objects to be monitored (for example, servers that perform various kinds of processing) and a monitoring device that manages a plurality of devices to be monitored in a centralized manner, and detects an abnormality in a device to be monitored and collects information to track down the cause of the detected abnormality.

In particular, a monitoring device in a device monitoring system collects status information from a device to be monitored on a regular basis (i.e., status monitoring) and acquires the log of operation or status on a regular basis (i.e., log collection).

Generally, the information that is related to the status of a device to be monitored is acquired by using standard technology such as SNMP (Simple Network Management Protocol) and IPMI (Intelligent Platform Management Interface) or using the agent of monitoring software.

Moreover, in the log collection of a device to be monitored, the log is generally acquired from the SEL (system event log) retained by a BMC (Baseboard Management Controller) or from the log retained by the OS of a device to be monitored, e.g., syslog in UNIX (registered trademark) and event log in Windows (registered trademark).

The above status monitoring process and log collection process are performed on a regular basis, but the frequencies with which these processes are performed are different from each other due to their varying purposes. Because the purpose of the status monitoring is to detect an abnormality, the frequency with which the process is performed is set to a short cycle (for example, one time/minute). Because the log collection is acceptable as long as the log is not lost, the frequency with which the process is performed is set to a relatively long cycle (for example, one time/week).

It is a known conventional method to prepare two kinds of time intervals at which monitoring information is acquired when a server is monitored, where the time interval is changed to either one of the two kinds of time intervals depending on the schedule.

In view of its purpose, it is preferred that the status monitoring have a high frequency with which the process is performed. However, if the load on a device to be monitored is considered, it is preferable to prevent a load on the device when the device to be monitored is normally operating, and thus it is preferable that the frequency of monitoring be low. When a sign that may lead to an abnormality is found from a device to be monitored, it is preferred that the frequency of monitoring be set high. Once an abnormality has actually been detected, the frequency of monitoring may be set low as the abnormality has already been recognized.

On the other hand, the log collection aims at collecting information to track down the cause of a problem. Thus, it is preferred that the frequency with which the process is performed be low until an abnormality is detected, and that the frequency with which the log is collected be high so as not to lose information after an abnormality has been detected because the speed at which the log information is accumulated becomes high after the abnormality has been detected.

However, the frequency with which status monitoring is performed and the frequency with which log collection is performed are both constant in the conventional server monitoring systems regardless of whether an abnormality has been detected. For this reason, there have been the following problems.

There have been some cases in which an excessive load is placed upon a device because the frequency of monitoring for a device to be monitored that is normally operating is too high.

There has been a risk that a load will be continuously placed upon a device in which an error is occurring because the status monitoring is performed with the same frequency even after the detection of an abnormality.

There has been the possibility that log information that is valid for tracking down the cause of a problem will be overwritten if the interval since the occurrence of an abnormality until the next acquisition of log information is too long. Thus, there has been a risk that the chances of acquiring information that contributes to specifying the cause of a problem will be lost.

In the conventional monitoring systems, the occurrence patterns of future events are estimated according to the occurrence of the first event, and the frequency of monitoring is made variable according to the estimated occurrence patterns. In other words, the intervals at which monitoring is performed are controlled according to schedules that are specified in advance. However, it has been impossible for such monitoring systems to change the intervals at which monitoring is performed according to the change in the status of a device to be monitored.

[Patent Document 1] Japanese Laid-open Patent Publication No. 2006-319707

### SUMMARY

A device monitoring system disclosed herein includes: a status information storage unit configured to store status of a plurality of monitoring items for each device to be monitored; an abnormality monitoring unit configured to detect a change in the status of monitoring items stored in the status information storage unit, and to define a status monitoring frequency of acquisition of the status of monitoring items from the device to be monitored, according to the detected change in status; and a status monitoring unit configured to acquire the status of monitoring items from the device to be monitored according to the status monitoring frequency, and to store the acquired status of the monitoring items in the status information storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of the configuration of a device monitoring system disclosed as one embodiment of the present invention.

FIG. 2 depicts examples of the monitoring frequency definition stored in a monitoring condition storage unit according to one embodiment.

FIG. 3 depicts examples of the status information stored in a status information storage unit according to one embodiment.

FIG. 4 illustrates an example of the configuration of an abnormality monitoring unit according to one embodiment.

FIG. 5 illustrates an example of the processing flow of a status acquisition unit according to one embodiment.

FIG. 6 depicts an example of the status difference data according to one embodiment.

FIG. 7 illustrates an example of the processing flow of a status assessment unit according to one embodiment.

FIG. 8 depicts an example of the change instruction data according to one embodiment.

FIG. 9 illustrates an example of the processing flow of a change instruction unit according to one embodiment.

FIG. 10 illustrates an example of the configuration of a status monitoring unit according to one embodiment.

FIG. 11 illustrates an example of the processing flow of a monitoring frequency change instruction unit according to one embodiment.

FIG. 12 depicts examples of the frequency of status monitoring stored in the status monitoring frequency storage unit according to one embodiment.

FIG. 13 illustrates an example of the processing flow of an analysis unit according to one embodiment.

FIG. 14 illustrates an example of the processing flow of a scheduling unit according to one embodiment.

FIG. 15 illustrates an example of the processing flow of a status acquisition unit according to one embodiment.

FIG. 16 illustrates an example of the configuration of a log monitoring unit according to one embodiment.

FIG. 17 depicts examples of the frequency of log monitoring stored in a log monitoring frequency storage unit according to one embodiment.

FIG. 18 illustrates an example of the configuration of a device monitoring system according to an embodiment disclosed herein.

FIGS. 19A-19F depict examples of the status information, status difference data, change instruction data, and schedule data in the first embodiment.

FIGS. 20A-20E depict examples of the status information, status difference data, change instruction data, and schedule data in the second embodiment.

FIG. 21 depicts examples of the schedule data according to the second embodiment.

FIG. 22 illustrates an example of the hardware configuration of a monitoring server according to one embodiment.

### DESCRIPTION OF EMBODIMENTS

A device monitoring system that monitors a plurality of monitoring items of a plurality of devices as objects to be monitored according to one aspect of the present invention will be described below.

According to a device monitoring system as disclosed below, devices may be monitored in an efficient manner by changing the frequency of status monitoring or log collection according to the status of a device to be monitored.

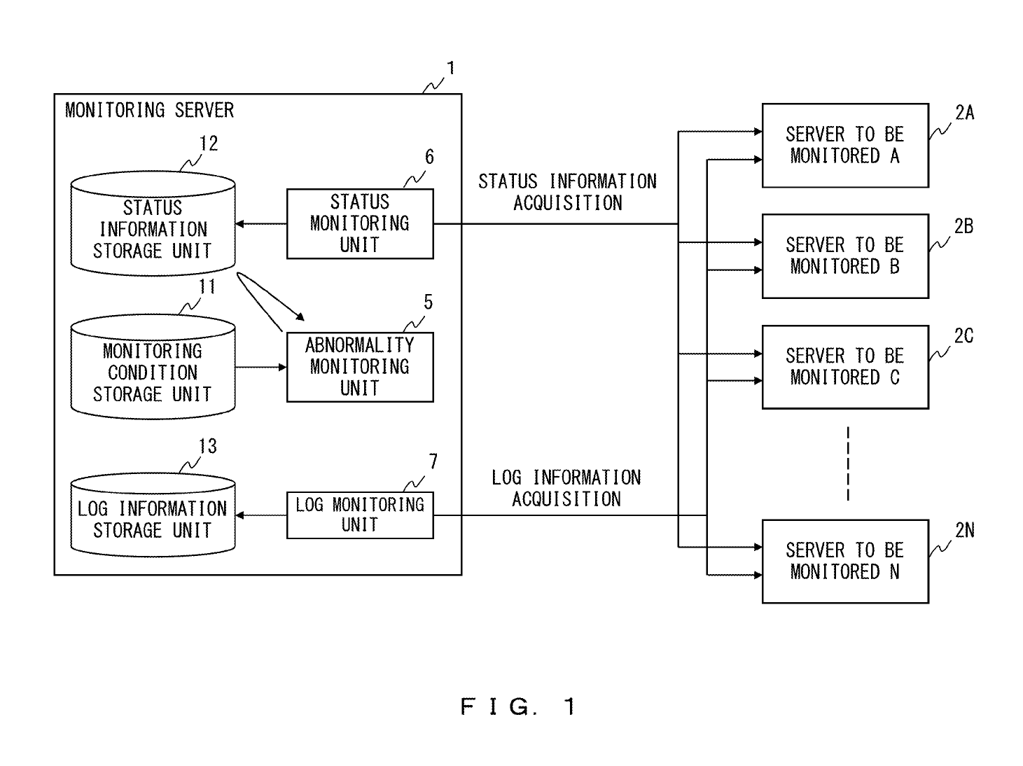

FIG. 1 illustrates an example of the configuration of a device monitoring system disclosed as one embodiment of the present invention.

A device monitoring system is provided with a plurality of devices to be monitored (servers to be monitored) 2A, 2B, 2C, . . . , and 2N, and a monitoring device (monitoring server) 1.

The monitoring server 1 is based on a known monitoring device, and further includes an abnormality monitoring unit 5 and a monitoring condition storage unit 11 as new elements. When a change is detected in the status of the servers to be monitored 2A, 2B, 2C, . . . , and 2N, the monitoring server 1 instructs the server to be monitored 2 to change the frequency of status monitoring or the frequency of log monitoring according to the monitoring frequency definition stored in advance. The monitoring server 1 may be implemented as a computer provided with a CPU and a memory, or as dedicated hardware.

The monitoring server 1 includes a monitoring condition storage unit 11, a status information storage unit 12, a log information storage unit 13, an abnormality monitoring unit 5, a status monitoring unit 6, and a log monitoring unit 7.

The monitoring condition storage unit 11 stores a monitoring frequency definition in which the frequency of status monitoring, which is the frequency of a status information acquisition process, and the frequency of log monitoring, which is the frequency of a log information collection process, are stored for the status of each monitoring item.

The status information storage unit 12 stores status information that indicates the status of the servers to be monitored 2 related to specified monitoring items. The monitoring items indicate specified items to be monitored, and include, for example, the status of CPU operation, resource usage, a power source, a voltage, and a cabinet.

The log information storage unit 13 stores the log information of specified monitoring items collected from the servers to be monitored 2. The log information is the record of the operation of a device or installed software on the monitoring items.

When a change in status is detected from the status information stored in the status information storage unit 12, the abnormality monitoring unit 5 changes the frequency of status monitoring on the relevant servers to be monitored 2 and on monitoring items, and notifies the status monitoring unit 6 of the changed frequency of status monitoring.

Moreover, when a change in status is detected from the status information stored in the status information storage unit 12, the abnormality monitoring unit 5 changes the frequency of log monitoring on the corresponding servers to be monitored 2 and on monitoring items, and notifies the log monitoring unit 7 of the changed frequency of log monitoring.

The abnormality monitoring unit 5 may provide notification of the frequency of status monitoring or log monitoring on the relevant server to be monitored 2 and the server to be monitored 2 related to the monitoring item, or on the monitoring items.

The status monitoring unit 6 generates a schedule for status monitoring according to the notification of the frequency of status monitoring provided by the abnormality monitoring unit 5, and acquires the status of monitoring items from the servers to be monitored 2 and stores the acquired status of the monitoring items in the status information storage unit 12.

The log monitoring unit 7 generates a schedule for log monitoring according to the notification of the frequency of log monitoring provided by the abnormality monitoring unit 5, and acquires log information from the servers to be monitored 2 and stores the acquired log information in the log information storage unit 13.

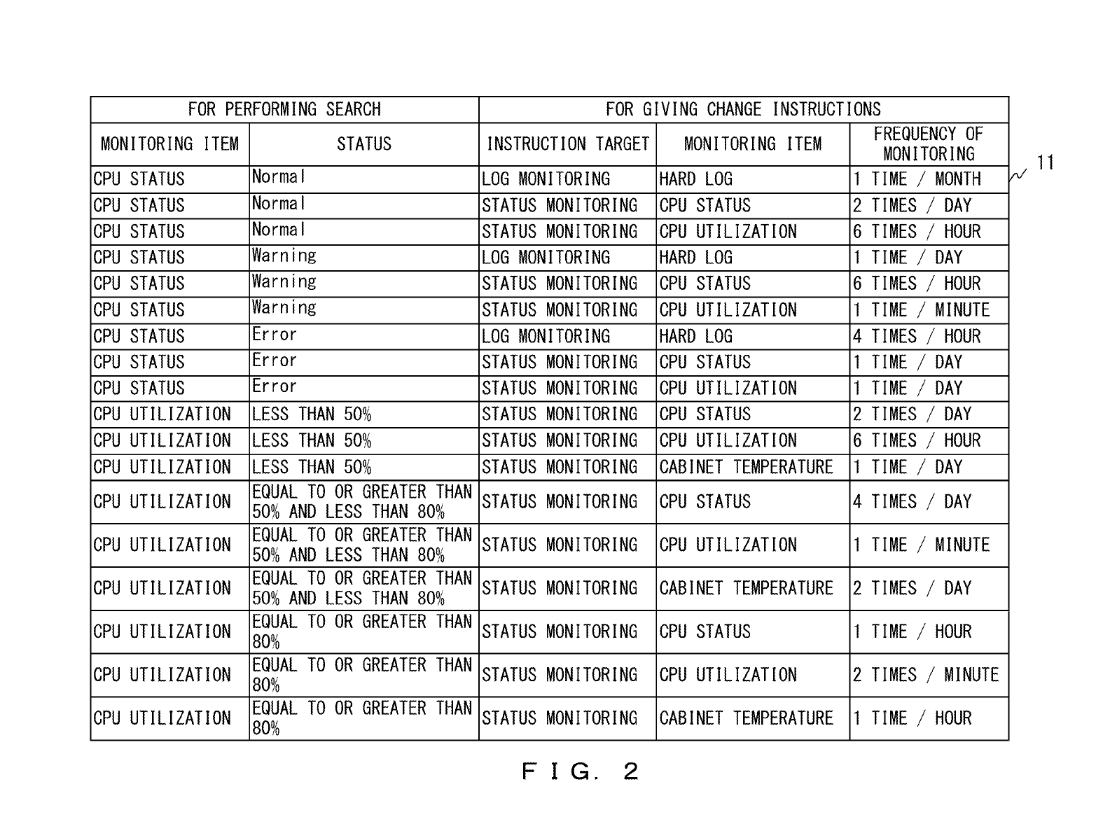

FIG. 2 depicts examples of the monitoring frequency definition stored in the monitoring condition storage unit 11.

The monitoring frequency definition has the data items including a monitoring item and status for performing a search, and an instruction target, a monitoring item, and a frequency of monitoring for giving change instructions. The monitoring items and status for performing a search define the status where the frequency of status monitoring or log monitoring is to be changed. The instruction target and monitoring item for giving change instructions defines the details of the instructed frequency of status monitoring or log monitoring.

The instruction target for giving change instructions indicates the process of changing a frequency, and either one of “status monitoring” or “log monitoring” is assigned to the instruction target. The monitoring item indicates the item whose frequency of monitoring is to be changed, and the frequency of monitoring indicates the details of the frequency with which a change is made.

In the monitoring frequency definition of FIG. 2, when the status information acquired from the server to be monitored 2A indicates the status “Warning” for the monitoring item “CPU status”, it is indicated that the frequency of log information acquisition of the monitoring item “hard log (indicating hardware log information)” as “log monitoring”, the frequency of status information acquisition of the monitoring item “CPU status” as “status monitoring”, and the frequency of status information acquisition of the monitoring item “CPU utilization” are changed to “once a day (one time/day)”, “six times an hour (six times/hour)”, and “once a minute (one time/minute)”, respectively.

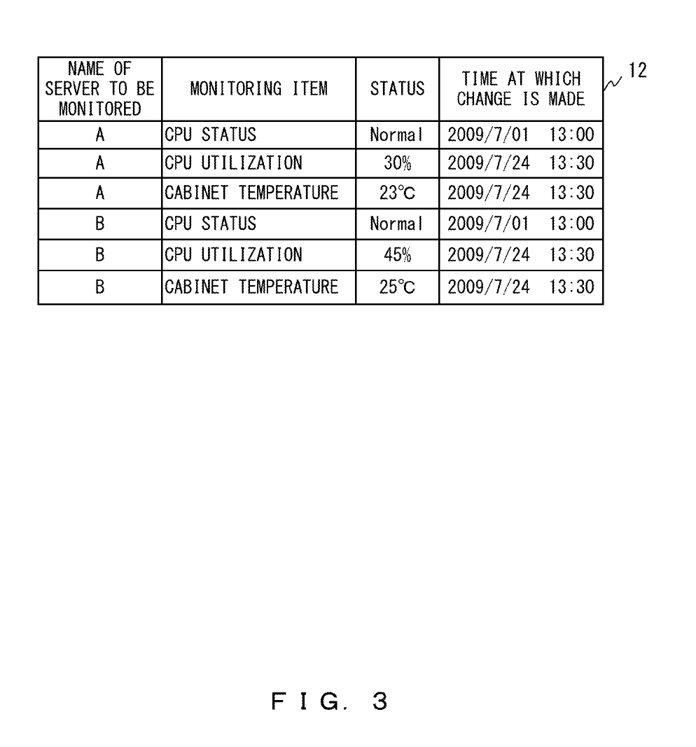

FIG. 3 depicts examples of the status information stored in the status information storage unit 12.

The status information has the data items including the name of a server to be monitored, a monitoring item, status, and a time at which a change is made.

The name of a server to be monitored is the information used to identify the server to be monitored 2. The monitoring item indicates an item to be monitored, and the status indicates the status of the server to be monitored 2 related to the monitoring item. The time at which a change is made indicates the date and time when the status information is written into the status information storage unit 12.

Hereinafter, the processing units of the monitoring server 1 will be described in detail.

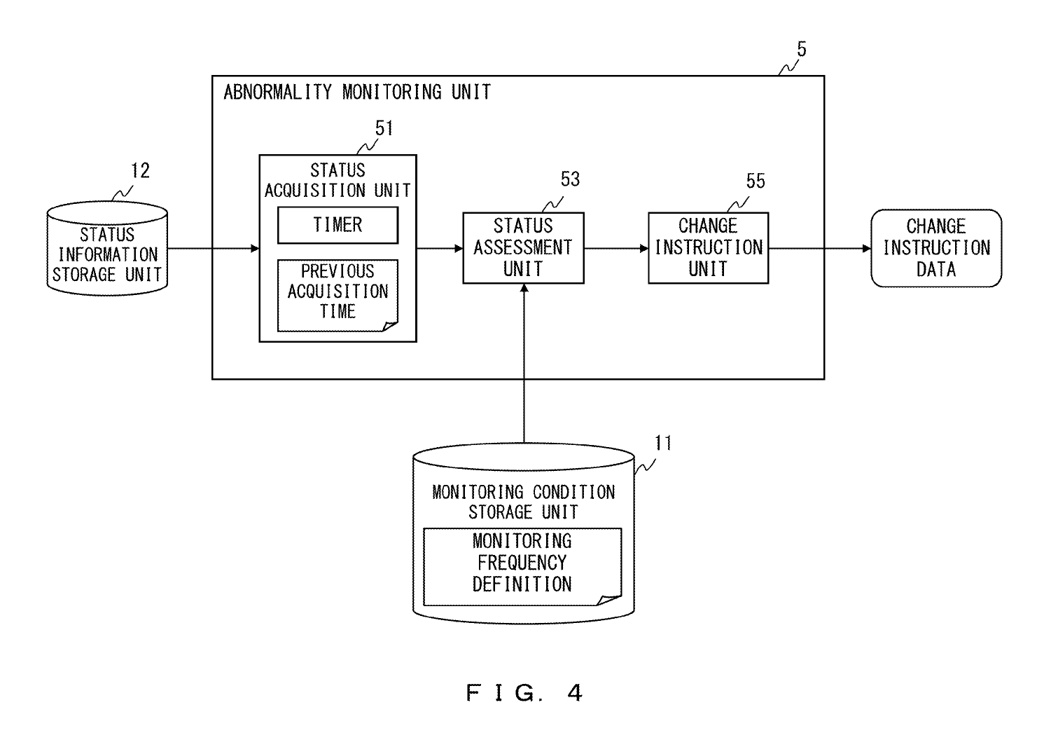

FIG. 4 illustrates an example of the configuration of the abnormality monitoring unit 5.

The abnormality monitoring unit 5 monitors the status information storage unit 12 on a regular basis, and generates change instruction data that includes instructions to change the frequency of status monitoring or log monitoring according to the changes in the status information stored in the status information storage unit 12. Then, the abnormality monitoring unit 5 instructs the status monitoring unit 6 or the log monitoring unit 7 to make changes.

The abnormality monitoring unit 5 includes a status acquisition unit 51, a status assessment unit 53, and a change instruction unit 55.

The status acquisition unit 51 monitors the status information storage unit 12 on a regular basis to detect a change in the status information, and provides the status assessment unit 53 with difference data that indicates the change in the status information. The status acquisition unit 51 includes a time inside, and holds “previous acquisition time” that indicates the date and time when the status information storage unit 12 previously executed the monitoring process.

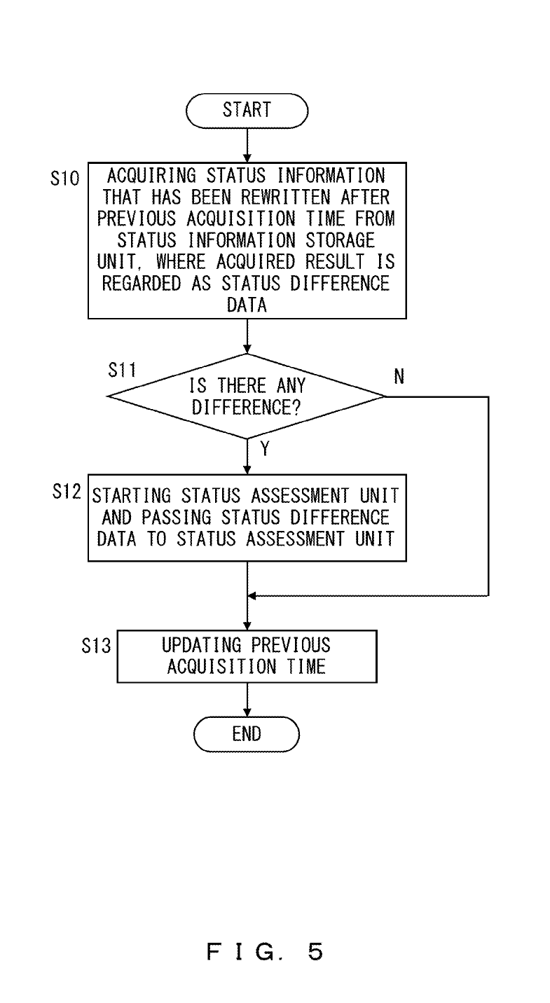

FIG. 5 illustrates an example of the processing flow of the status acquisition unit 51.

When the status acquisition unit 51 is started by a timer at regular intervals, the status acquisition unit 51 acquires from the status information storage unit 12 the status information that has been rewritten after the previous acquisition time, and regards the acquired result as status difference data (step S10). When there is a difference (status difference data) in the status information (“Y” in step S11), the status acquisition unit 51 starts the status assessment unit 53 and passes the status difference data to the status assessment unit 53 (step S12). When there is no difference (status difference data) in the status information (“N” in step S11), the process in step S12 is not performed. Then, the status acquisition unit 51 updates the previous acquisition time by the time when the present acquisition process is performed (step S13), and terminates the process.

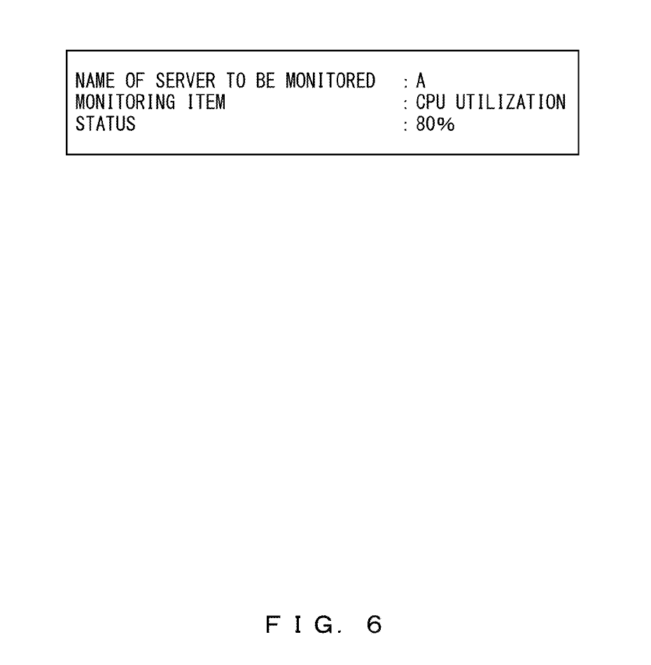

FIG. 6 depicts an example of the status difference data.

The status difference data includes the server to be monitored 2 from which a change in status is detected, the monitoring item rewritten after the previous acquisition time, and the status.

The status assessment unit 53 uses the changes in the status difference data (monitoring items, status) as a search key to search the monitoring frequency definition in the monitoring condition storage unit 11. By so doing, the status assessment unit 53 acquires a relevant instruction target, monitoring item, and a frequency of monitoring for giving change instructions, and generates change instruction data.

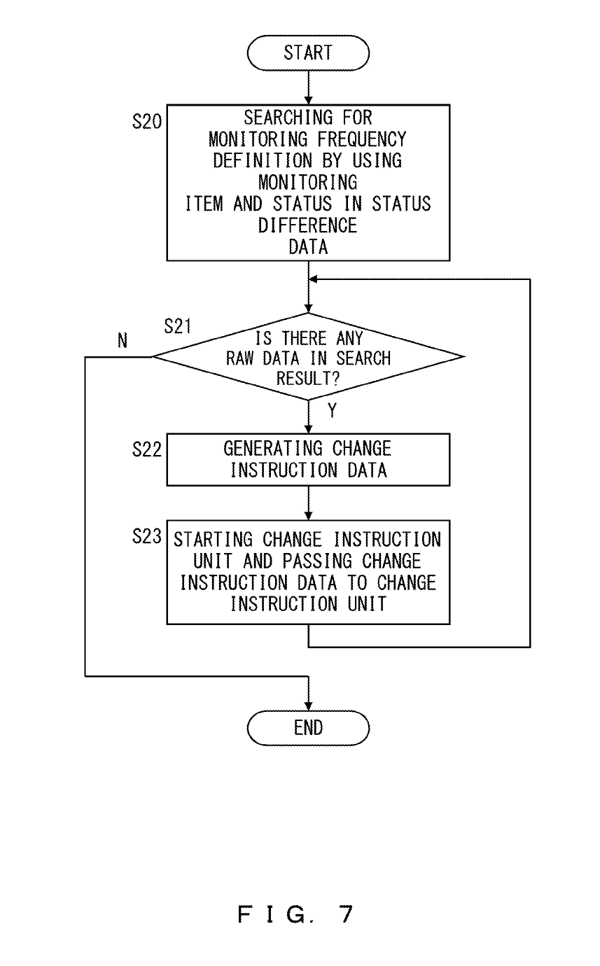

FIG. 7 illustrates an example of the processing flow of the status assessment unit 53.

The status assessment unit 53 searches for monitoring frequency definition in the monitoring condition storage unit 11 by using the monitoring item and status in the status difference data received from the status acquisition unit 51 (step S20). When there is any raw data in the search result (“Y” in step S21), the status assessment unit 53 generates change instruction data by using data such as an instruction target, a monitoring item, and a frequency of monitoring for giving change instructions that correspond to the relevant monitoring item and status for performing search (step S22). Then, the status assessment unit 53 starts the change instruction unit 55 and passes the change instruction data to the change instruction unit 55 (step S23). When there is no raw data in the search result (“N” in step S21), the status assessment unit 53 terminates the process.

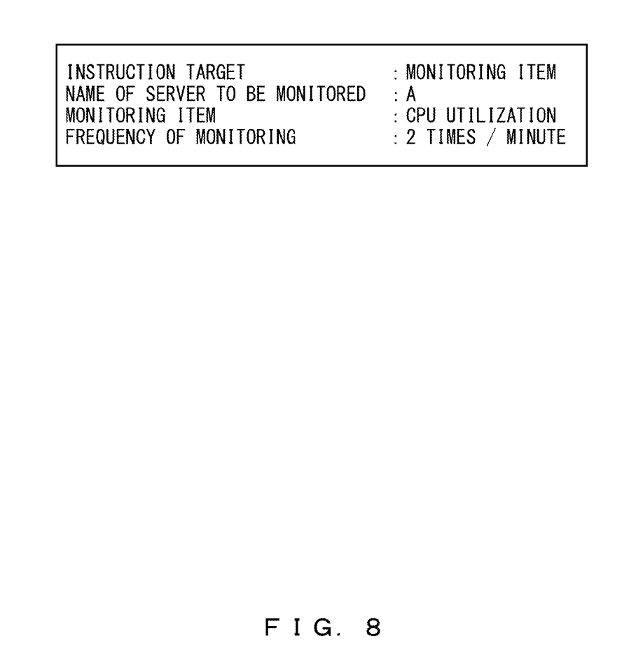

FIG. 8 depicts an example of the change instruction data.

The change instruction data includes an instruction target that represents the process for which the frequency of its performance is to be changed, the name of a server to be monitored that represents the server to be monitored 2, a monitoring item, and a frequency of monitoring that represents the frequency of being changed.

The change instruction unit 55 instructs the status monitoring unit 6 or the log monitoring unit 7 to change the frequency of monitoring according to the contents of the change instruction data received from the status assessment unit 53.

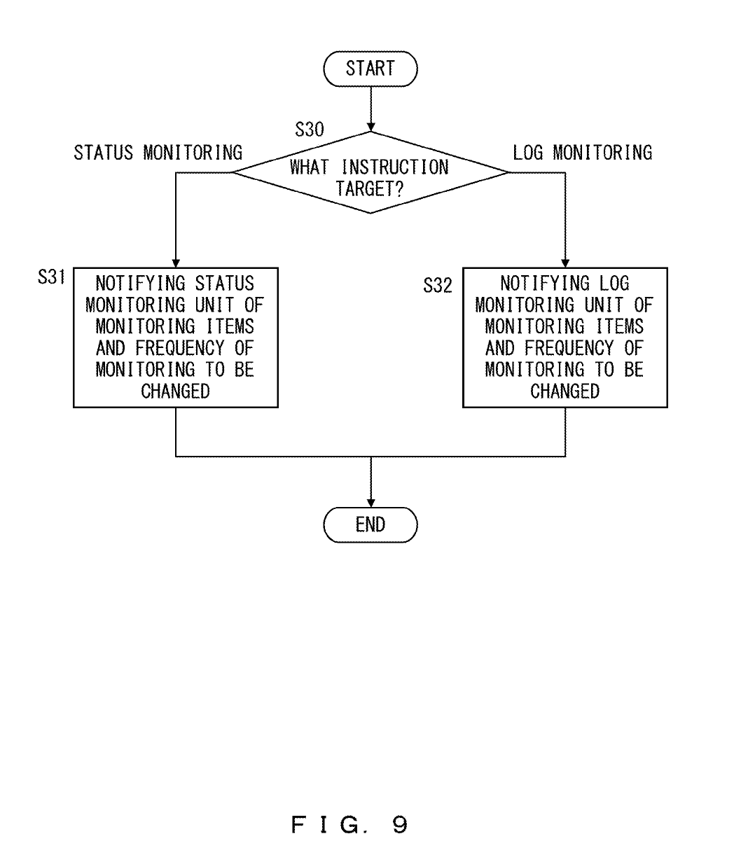

FIG. 9 illustrates an example of the processing flow of the change instruction unit 55.

The change instruction unit 55 examines the instruction target of the change instruction data, when the instruction target is status monitoring (“status monitoring” in step S30), the change instruction unit 55 notifies the status monitoring unit 6 of the monitoring items and frequency of monitoring to be changed (step S31). When the instruction target is log monitoring (“log monitoring” in step S30), the change instruction unit 55 notifies the log monitoring unit 7 of the monitoring items and frequency of monitoring to be changed (step S32).

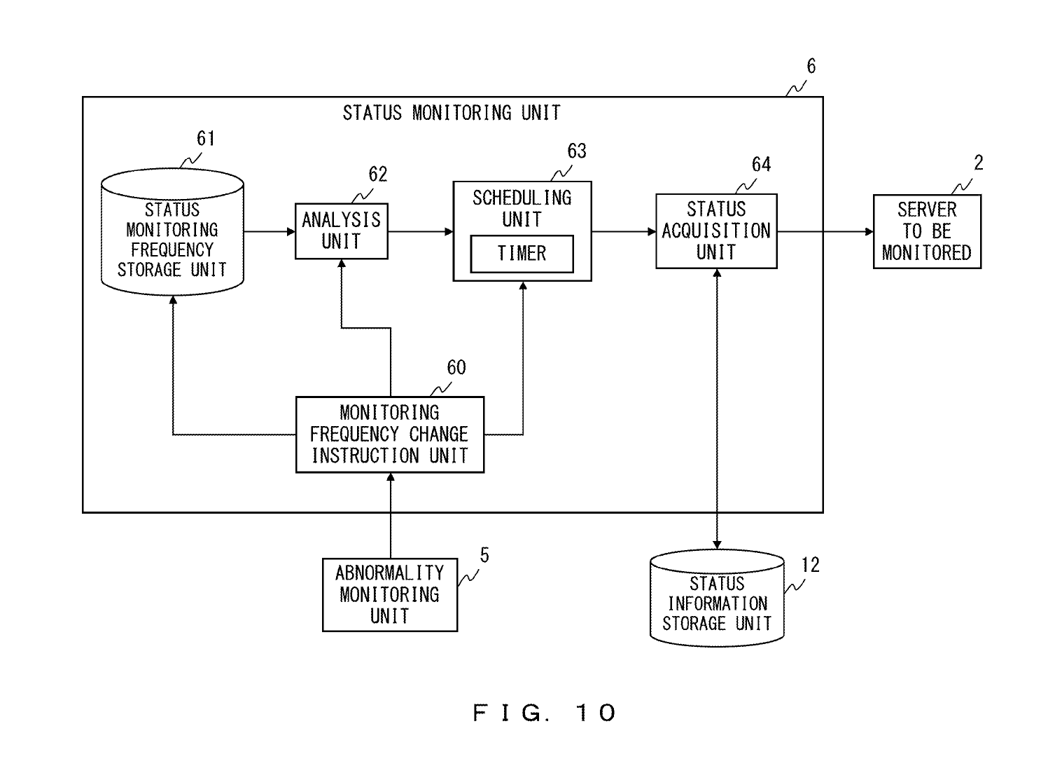

FIG. 10 illustrates an example of the configuration of the status monitoring unit 6.

The status monitoring unit 6 generates a schedule for status monitoring according to the change instruction given by the abnormality monitoring unit 5, and acquires status information from the server to be monitored 2.

The status monitoring unit 6 is provided with a monitoring frequency change instruction unit 60, a status monitoring frequency storage unit 61, an analysis unit 62, a scheduling unit 63, and a status acquisition unit 64.

The monitoring frequency change instruction unit 60 receives the change instruction data given by the abnormality monitoring unit 5, and stores the received change instruction data (of monitoring items and the frequency of monitoring) in the status monitoring frequency storage unit 61. Then, the monitoring frequency change instruction unit 60 requests the analysis unit 62 to analyze the frequency of status monitoring and to change the schedule.

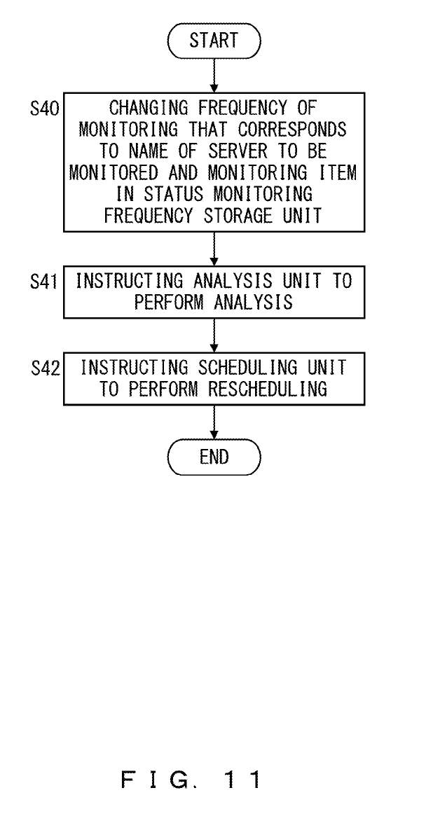

FIG. 11 illustrates an example of the processing flow of the monitoring frequency change instruction unit 60.

The monitoring frequency change instruction unit 60 receives from the abnormality monitoring unit 5 the notification of the change in the frequency of monitoring, and updates the status monitoring frequency storage unit 61 by using the obtained monitoring item whose frequency of monitoring is to be changed and the obtained frequency of monitoring (step S40). Next, the monitoring frequency change instruction unit 60 instructs the analysis unit 62 to analyze information in the status monitoring frequency storage unit 61 and to generate schedule data (step S41), and also instructs the scheduling unit 63 to perform rescheduling (step S42). Then, the process is terminated.

The status monitoring frequency storage unit 61 stores the status monitoring frequency on the monitoring items for which status monitoring is performed.

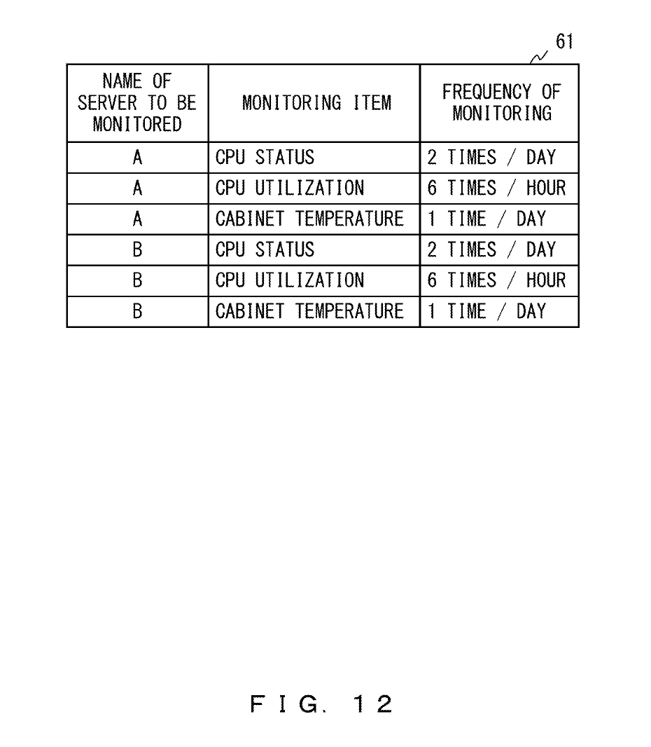

FIG. 12 depicts examples of the frequency of status monitoring stored in the status monitoring frequency storage unit 61.

The frequency of status monitoring includes the name of a server to be monitored that indicates an object to be monitored, monitoring items, and frequency of monitoring. In an example of the frequency of status monitoring depicted in FIG. 12, it is specified that the status information of the monitoring item “CPU status” for the name of a server to be monitored “A” is acquired as one item of status monitoring with the frequency of monitoring of “twice a day (two times/day)”.

The analysis unit 62 analyzes the frequency of status monitoring in the status monitoring frequency storage unit 61, and creates schedule data for status monitoring. In the schedule data, the server to be monitored and monitoring items for which status monitoring is performed are associated with the estimated time of execution and chronologically arranged.

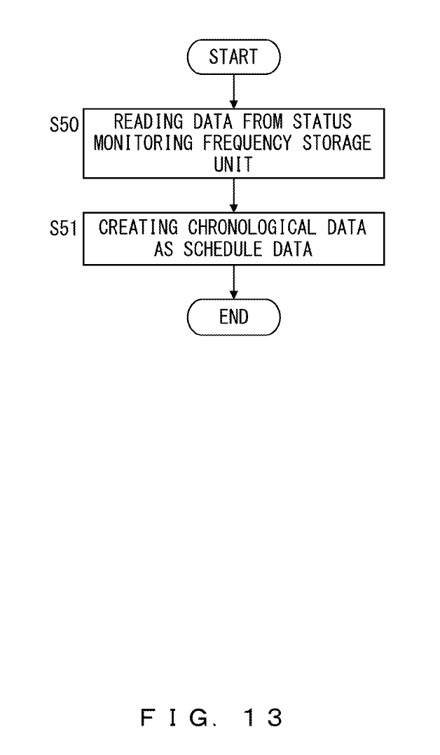

FIG. 13 illustrates an example of the processing flow of the analysis unit 62.

The analysis unit 62 reads a frequency of status monitoring in the status monitoring frequency storage unit 61 (step S50), and analyzes the read frequency of status monitoring to create chronological data of the execution schedule of status monitoring as schedule data (step S51). Then, the process is terminated.

The scheduling unit 63 includes a timer inside, and instructs the status acquisition unit 64 to acquire status information according to the schedule data created and modified by the analysis unit 62.

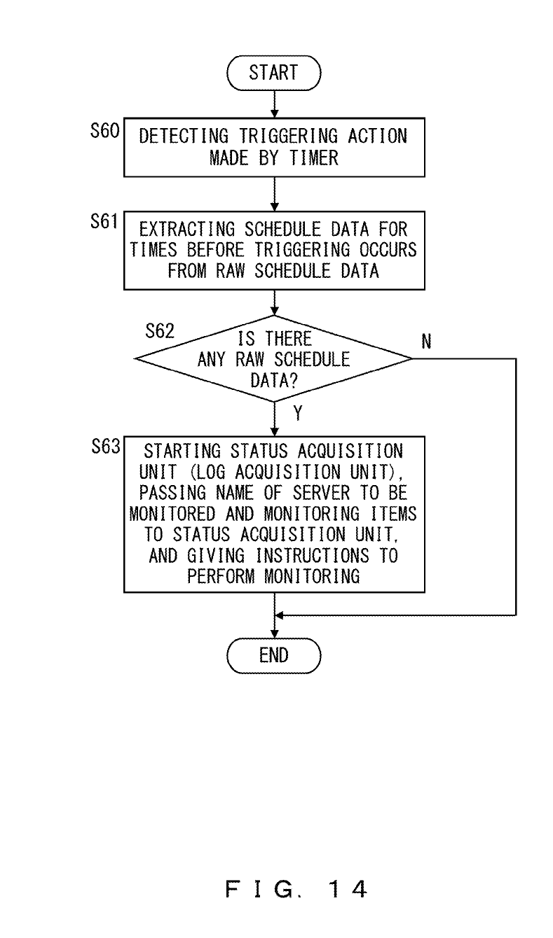

FIG. 14 illustrates an example of the processing flow of the scheduling unit 63.

When the internal timer triggers the processing on a constant basis, the scheduling unit 63 detects the triggering action (step S60), and extracts from raw schedule data the schedule data for times before the triggering occurs (step S61). If there is any raw schedule for times before the triggering occurs in the schedule data (“Y” in step S62), the scheduling unit 63 starts the status acquisition unit 64, and passes the name of a server to be monitored and monitoring items to the status acquisition unit 64 according to the schedule data. Then, the scheduling unit 63 instructs the status acquisition unit 64 to monitor the status (i.e., to acquire status information) (step S63), and terminates the process. If there is no raw schedule (“N” in step S62), the process in step S63 is not performed.

The status acquisition unit 64 acquires the status information that indicates the status of monitoring items from the specified server to be monitored 2, and updates the status information in the status information storage unit 12 when the acquired status information does not match the status information stored in the status information storage unit 12.

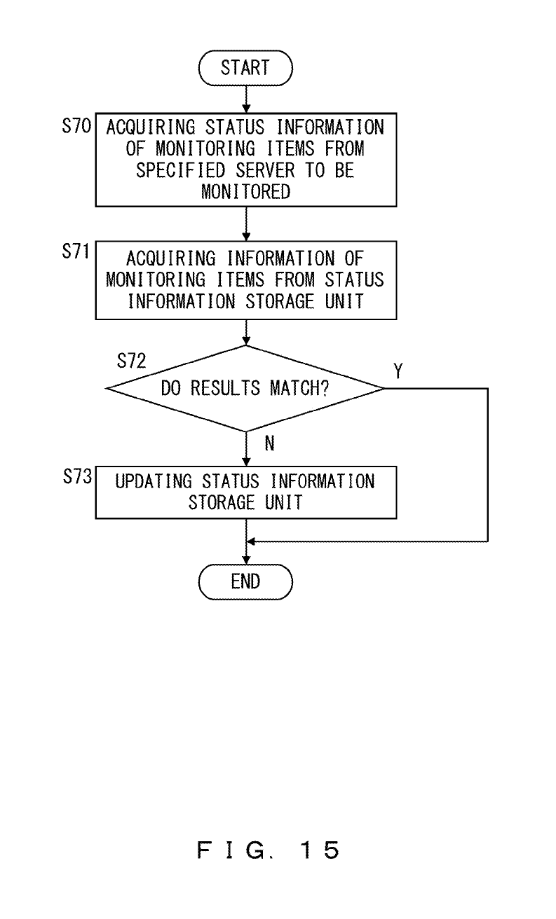

FIG. 15 illustrates an example of the processing flow of the status acquisition unit 64.

The status acquisition unit 64 acquires the status of monitoring items (status information) from the server to be monitored 2 specified by the scheduling unit 63 (step S70). Next, the status acquisition unit 64 acquires the status information of the monitoring items related to the relevant server to be monitored 2 from the status information storage unit 12 (step S71), and examines whether the acquired status matches the status extracted from the status information storage unit 12 (step S72). When the two items of status do not match (“N” in step S72), the status acquisition unit 64 updates the status of the relevant monitoring item in the status information storage unit 12 by using the acquired status, and updates the time at which a change is made (step S73). Then, the process is terminated. When the two items of status match (“Y” in step S72), the process in step S73 is not performed.

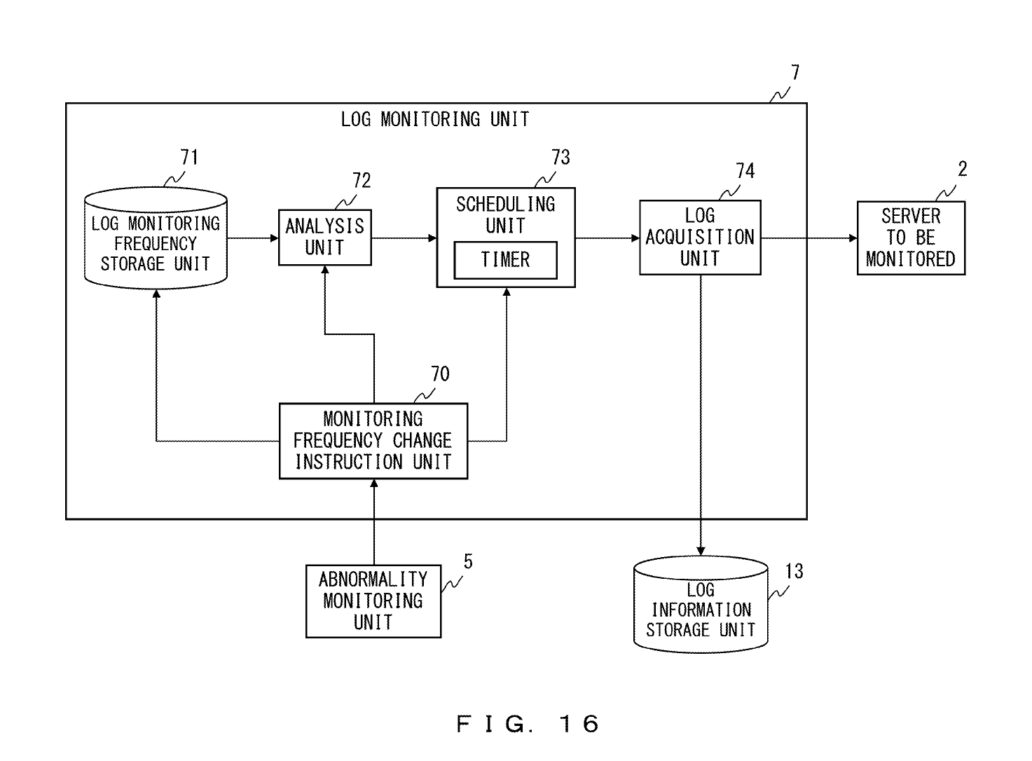

FIG. 16 illustrates an example of the configuration of the log monitoring unit 7.

The log monitoring unit 7 generates a schedule for log monitoring according to the notification of the change instruction data provided by the abnormality monitoring unit 5, and acquires log information from the servers to be monitored 2.

The log monitoring unit 7 includes a monitoring frequency change instruction unit 70, a log monitoring frequency storage unit 71, an analysis unit 72, a scheduling unit 73, and a log acquisition unit 74.

The monitoring frequency change instruction unit 70 receives the notification of the change instruction data provided by the abnormality monitoring unit 5, and stores details of the changes (in monitoring items and frequency of monitoring) in the log monitoring frequency storage unit 71. Then, the monitoring frequency change instruction unit 70 requests the analysis unit 72 to analyze the frequency of log monitoring and to change the schedule.

The log monitoring frequency storage unit 71 stores the frequency of monitoring at which log information of each monitoring item is acquired.

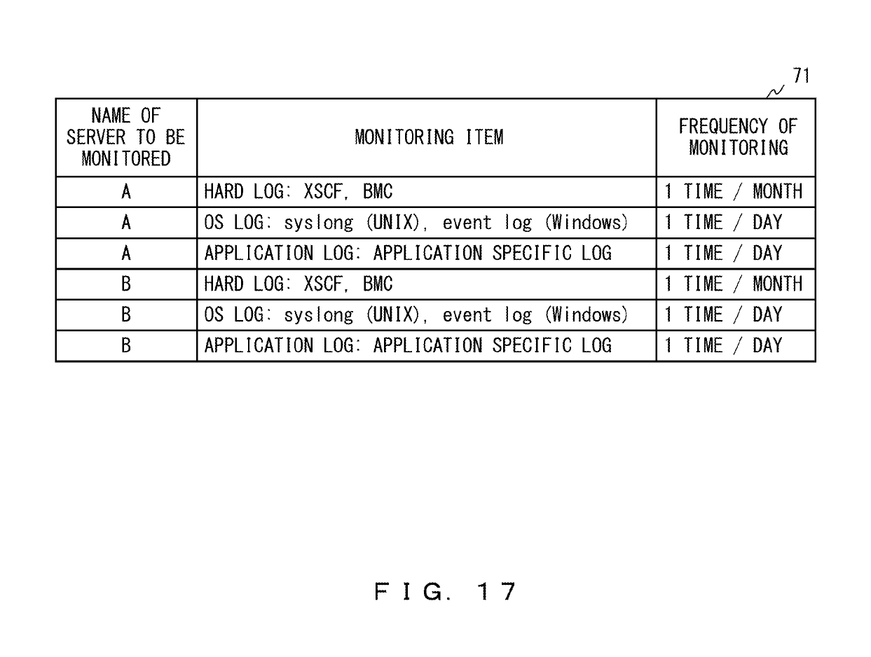

FIG. 17 depicts examples of the frequency of log monitoring stored in the log monitoring frequency storage unit 71.

The frequency of log monitoring includes the name of a server to be monitored that indicates an object to be monitored, monitoring items of which the log information is acquired, and the frequency of monitoring. “Application log: application specific log” in the monitoring items indicates the log information voluntarily accumulated by the application software that is executed in the server to be monitored 2. In the examples of the frequency of status monitoring depicted in FIG. 17, it is specified that the log information related to the monitoring item “hard log: XSCF, BMC” of the name of a server to be monitored “A” is acquired at the frequency of monitoring of “once a month (one time/month)” as one item of log monitoring.

The analysis unit 72 analyzes the information in the log monitoring frequency storage unit 71, and generates schedule data for log monitoring. In the schedule data, the server to be monitored and monitoring items for which log monitoring is performed are associated with the estimated time of execution and are chronologically arranged.

The scheduling unit 73 includes a time inside, and instructs the log acquisition unit 74 to acquire log information according to the schedule data generated by the analysis unit 72.

The log acquisition unit 74 acquires the log information related to the monitoring items from the specified server to be monitored 2, and stores the acquired log information in the log information storage unit 13.

Examples of the processing flow of the monitoring frequency change instruction unit 70, the analysis unit 72, the scheduling unit 73, and the log acquisition unit 74 are similar to the processing flow of the monitoring frequency change instruction unit 60, the analysis unit 62, the scheduling unit 63, and the status acquisition unit 64 illustrated in FIG. 11, and FIGS. 13-15. Thus the description is omitted.

Hereinafter, some embodiments of the status monitoring and log monitoring in a device monitoring system will be described.

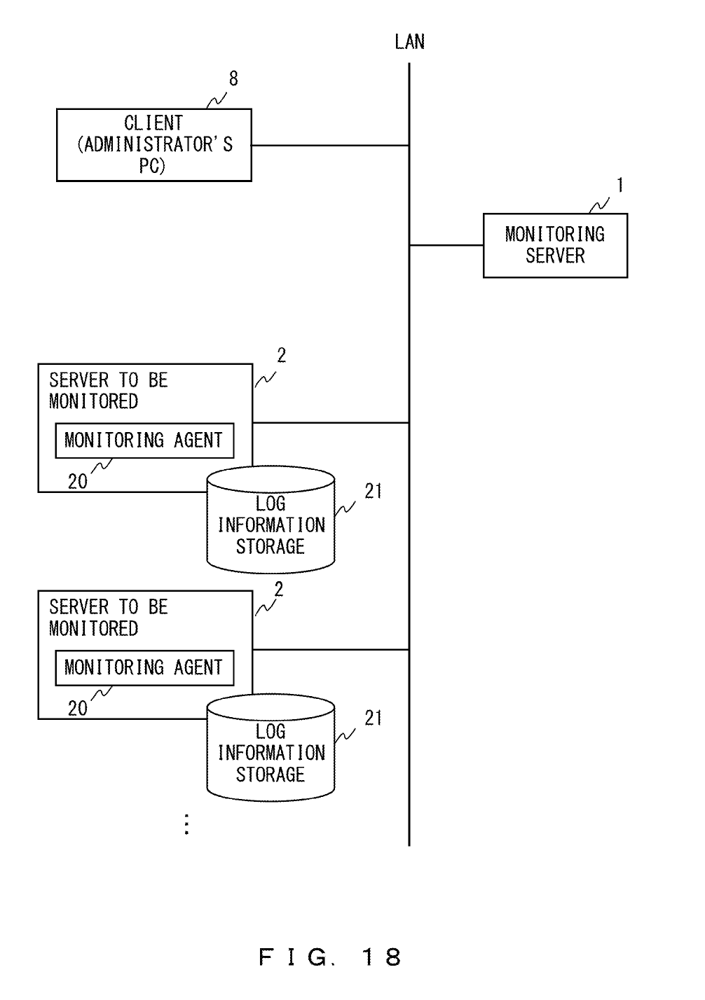

FIG. 18 illustrates an example of the configuration according to an embodiment.

In the present embodiment, a device monitoring system is provided with the monitoring server 1, the servers to be monitored 2, and a client 8 that is a computer of an administrator who receives the monitoring information.

In the present embodiment, the status information of the server to be monitored 2 is acquired by using known processing methods such as SNMP and IPMI or by using processing methods in which the information is acquired from the agent of a monitoring software program. The log information is acquired by using processing methods in which the information is acquired from the SEL retained by a BMC or by using processing methods in which the information is acquired from the log information retained by the OS of the server to be monitored 2.

Each of the servers to be monitored 2 has a monitoring agent 20 such as SNMP, IPMI, or another kind of monitoring software that collects the status information and log information of itself, and also has a log information storage device 21 that stores the log information collected by the monitoring agent 20.

The monitoring server 1 collects status information and log information from the server to be monitored 2 to monitor the status of the server to be monitored 2. In response to an information collection request from the monitoring server 1, the server to be monitored 2 returns the requested information. The client 8 implements the view of the device monitoring system, and provides a user with the monitoring information managed by the monitoring server 1.

### First Embodiment

As the first embodiment, how processes are operated when an error has occurred in the CPU of the server to be monitored 2A will be described.

It is assumed that the status information storage unit 12 stores status information as depicted in FIG. 3.

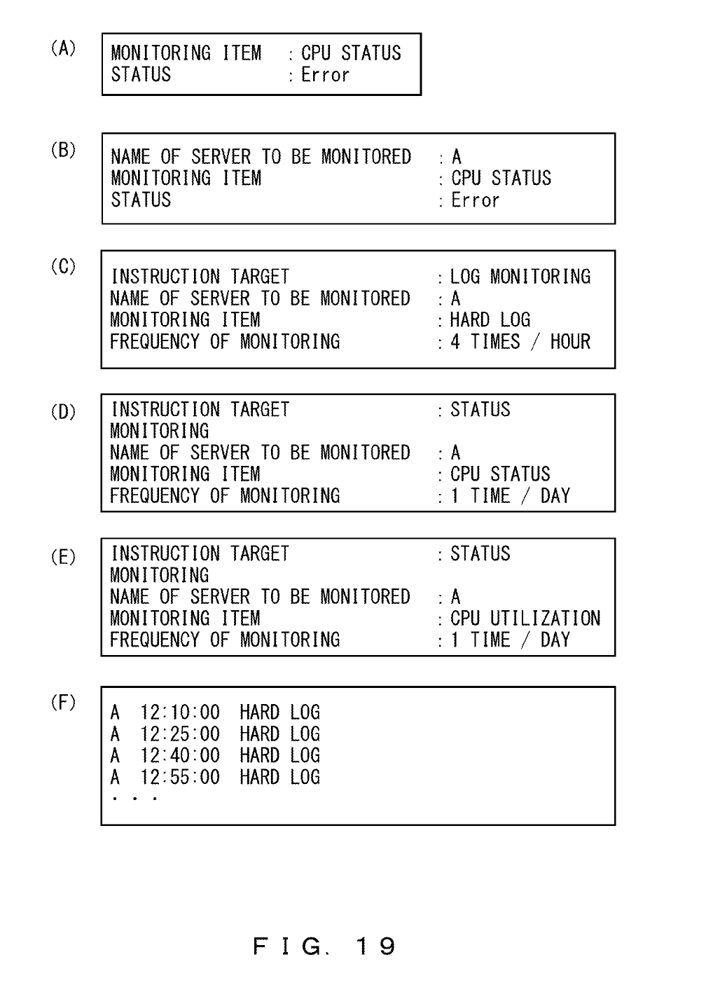

It is assumed that the status acquisition unit 64 in the status monitoring unit 6 has, at 12:00 on Jul. 25, 2009, acquired from the server to be monitored 2A the status information of the monitoring item “CPU status”, as depicted in FIG. 19A.

The status acquisition unit 64 updates the status and time at which a change is made on the relevant monitoring items in the status information storage unit 12. In particular, the status acquisition unit 64 changes the status of the monitoring item “CPU status” of the server to be monitored 2A to “Error”, and changes the time at which a change is made to “2009/07/25 12:00”.

Subsequent to that, the status acquisition unit 51 of the abnormality monitoring unit 5 refers to the status information storage unit 12 depicted in FIG. 3, and acquires the information that has been changed after the previous acquisition time (it is assumed that the previous acquisition time is 2009/07/25 11:55). Then, the status acquisition unit 51 of the abnormality monitoring unit 5 generates the status difference data depicted in FIG. 19B, and updates the “previous acquisition time” retained inside.

The status assessment unit 53 uses the monitoring item and status in the status difference data as a search key, and searches the monitoring frequency definition in the monitoring condition storage unit 11 of FIG. 2. Then, according to the search results, the status assessment unit 53 generates three items of change instruction data (one item of change instruction data related to the log monitoring, and two items of change instruction data related to the status monitoring) as depicted in FIGS. 19C-19E.

The change instruction unit 55 transmits change instruction data related to the frequency of monitoring to the status monitoring unit 6 and the log monitoring unit 7 according to the generated change instruction data.

The monitoring frequency change instruction unit 70 in the log monitoring unit 7 receives the change instruction data from the abnormality monitoring unit 5, and changes the frequency of log monitoring in the log monitoring frequency storage unit 71 accordingly. Further, the monitoring frequency change instruction unit 70 instructs the analysis unit 72 to analyze the frequency of log monitoring in the log monitoring frequency storage unit 71 and to generate schedule data.

When the analysis unit 72 recognizes due to the analysis that the frequency of monitoring the hard log of the server to be monitored 2A has been changed from “one time/month” to “four times/hour”, the analysis unit 72 generates schedule data for the server to be monitored 2A as depicted in FIG. 19F.

Further, the monitoring frequency change instruction unit 70 instructs the scheduling unit 73 to perform rescheduling. The scheduling unit 73 performs rescheduling according to the schedule data generated by the analysis unit 72. The scheduling unit 73 requests the log acquisition unit 74 to acquire a hard log from the server to be monitored 2A at the time set in the schedule data by a timer trigger.

In regard to the status monitoring by the status monitoring unit 6, change instruction data is acquired from the abnormality monitoring unit 5, and in a similar manner to the log monitoring, the frequency of status monitoring is changed. Then, a schedule for status monitoring is generated, and status information is collected.

### Second Embodiment

As the second embodiment, how processes are operated when the CPU utilization of the server to be monitored 2A exceeds 80% will be described.

It is assumed that the status information storage unit 12 stores status information as depicted in FIG. 3.

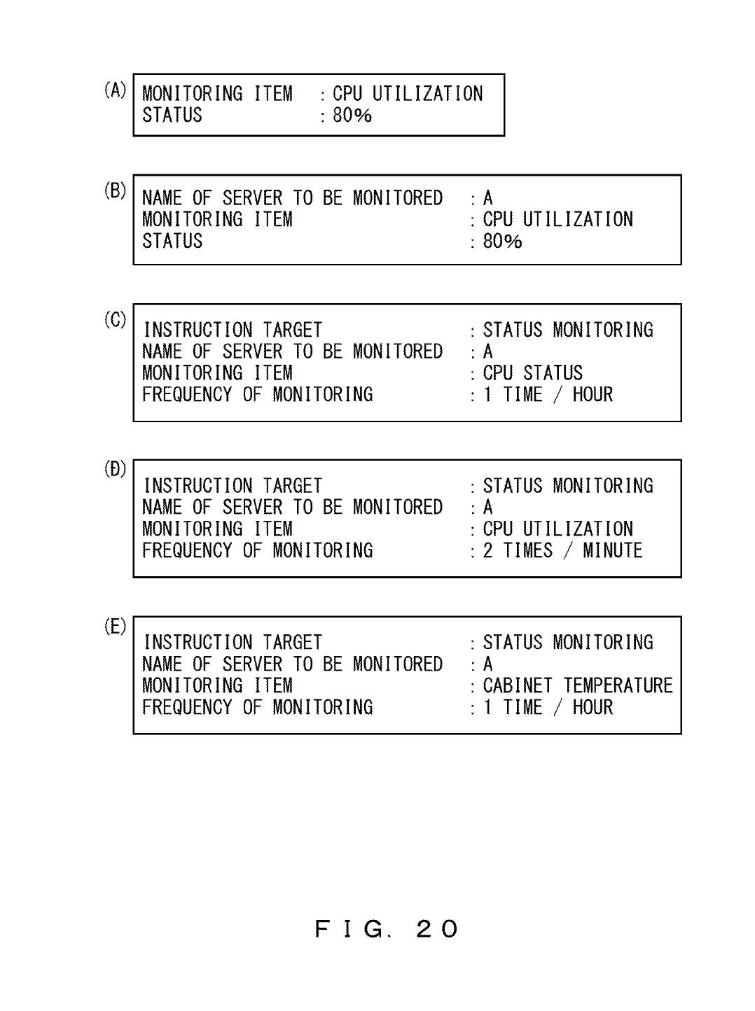

It is assumed that the status acquisition unit 64 in the status monitoring unit 6 has, at 12:00 on Jul. 25, 2009, acquired from the server to be monitored 2A the status information of the monitoring item “CPU utilization” as depicted in FIG. 20A.

The status acquisition unit 64 updates the status and time at which a change is made of the relevant monitoring items in the status information storage unit 12. In particular, the status acquisition unit 64 changes the status of the monitoring item “CPU utilization” of the server to be monitored 2A to “80%”, and changes the time at which a change is made to “2009/07/25 12:00”.

Subsequent to that, the status acquisition unit 51 of the abnormality monitoring unit 5 refers to the status information storage unit 12 depicted in FIG. 3, and acquires the information that has been changed after the previous acquisition time (it is assumed that the previous acquisition time is 2009/07/25 11:55). Then, the status acquisition unit 51 of the abnormality monitoring unit 5 generates the status difference data depicted in FIG. 20B, and updates the “previous acquisition time” retained inside.

The status assessment unit 53 uses the monitoring item and status in the status difference data as a search key, and searches the monitoring frequency definition in the monitoring condition storage unit 11 of FIG. 2. Then, according to the search results, the status assessment unit 53 generates three items of change instruction data related to the status monitoring as depicted in FIGS. 20C-20E.

The change instruction unit 55 instructs the status monitoring unit 6 to change the frequency of monitoring according to the generated change instruction data.

The monitoring frequency change instruction unit 60 in the status monitoring unit 6 receives the change instruction data related to the frequency of monitoring from the abnormality monitoring unit 5, and changes the frequency of status monitoring in the status monitoring frequency storage unit 61 accordingly. Further, the monitoring frequency change instruction unit 60 instructs the analysis unit 62 to analyze the information in the status monitoring frequency storage unit 61 and to generate schedule data.

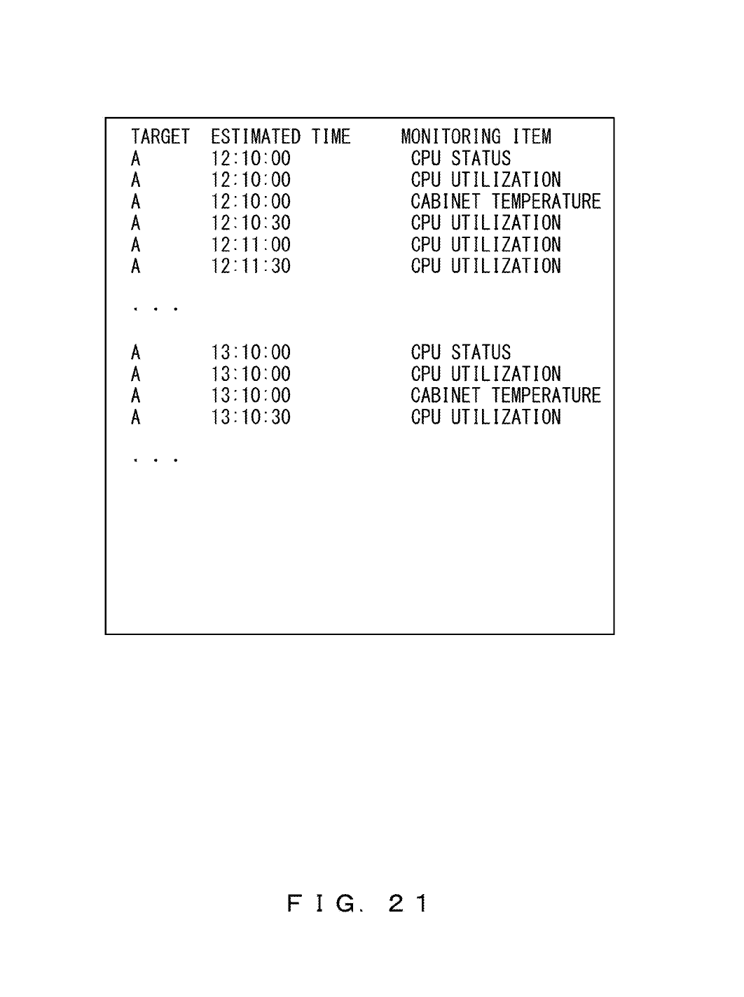

When the analysis unit 62 recognizes due to the analysis that the frequency of status monitoring on the monitoring items “CPU status”, “CPU utilization”, and “cabinet temperature” for the server to be monitored 2A has been changed from “two times/day”, “six times/hour”, and “one time/day” to “one time/hour”, “two times/minute”, and “one time/hour”, respectively, the analysis unit 62 generates schedule data for the server to be monitored 2A as depicted in FIG. 21.

Further, the monitoring frequency change instruction unit 60 instructs the scheduling unit 63 to perform rescheduling. The scheduling unit 63 performs rescheduling according to the schedule data generated by the analysis unit 62. The scheduling unit 63 requests the log acquisition unit 64 to acquire status information related to “CPU status, CPU utilization, cabinet temperature” from the server to be monitored 2A at the time set in the schedule data by a timer trigger.

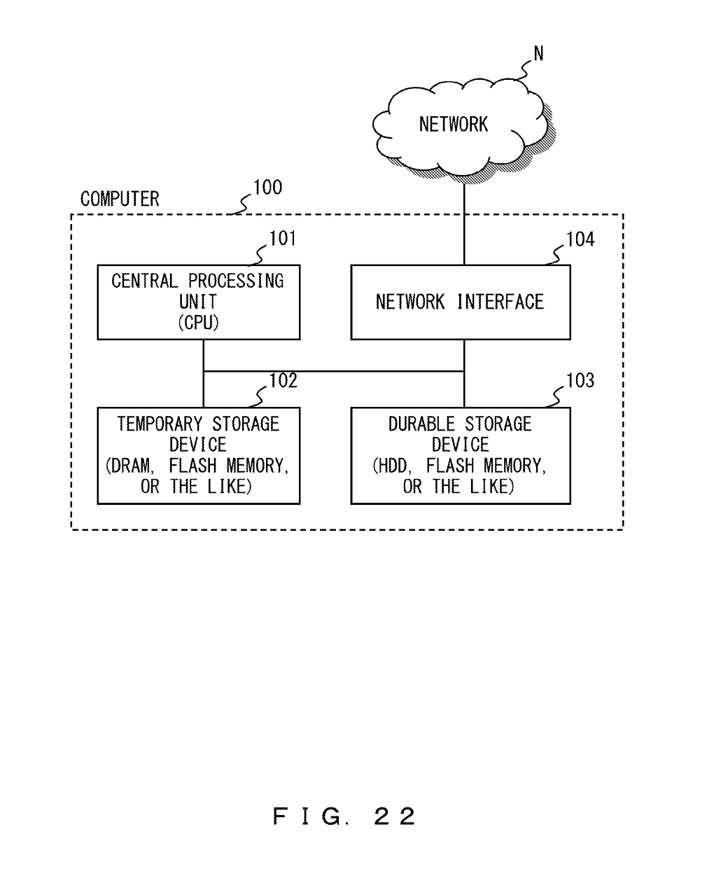

FIG. 22 illustrates an example of the hardware configuration of the monitoring server 1.

As illustrated in FIG. 22, the monitoring server 1 is implemented by a computer 100 provided with the CPU (processor) 101, a temporary storage device (DRAM, Flash Memory, or the like) 102, a durable storage device (HDD, Flash Memory, or the like) 103, and a network interface 104.

Note that the monitoring server 1 may be implemented by a program that is executable by the computer 100. In that case, a program is provided in which the processing operations of functions to be achieved by the monitoring server 1 are described. As the computer 100 executes the provided program, the processing functions of the monitoring server 1 as above are achieved on the computer 100.

In other words, the abnormality monitoring unit 5, the status monitoring unit 6, the log monitoring unit 7, or the like of the monitoring server 1 may be configured by a program, and the monitoring condition storage unit 11, the status information storage unit 12, and the log information storage unit 13 maybe configured by the durable storage device 103.

Note that the computer 100 may read a program from a portable recording medium in a direct manner, and may perform processes according to the program. Further, the program may be stored in a recording medium that is readable by the computer 100.

As described above, in regard to an object for which monitoring needs to be performed more frequently such as the server to be monitored 2A in which an error has occurred to the CPU or the state of the CPU utilization becomes high, a device monitoring system disclosed herein may perform monitoring in an efficient manner as the status or hard log of the CPU status is collected at a frequency higher than “Normal”.

Moreover, as depicted in FIG. 2, in the example of the monitoring item “CPU status” in the monitoring frequency definition that is stored in the monitoring condition storage unit 11, the frequency of monitoring is higher compared with “Normal” when the status is “Warning”, but the frequency of monitoring is set lower compared with the case of “Error”. By configuring as above, the monitoring is strengthened for the status that may lead to the failure of the CPU, and it becomes possible to detect the occurrence of an abnormality in a prompt manner. Moreover, when the “abnormality” as possibly predicted by the warning occurs, the frequency of monitoring is decreased so as to reduce the processing load on the status monitoring at the server to be monitored 2. As the frequency of monitoring is set high when the status forecasts the occurrence of an abnormality, it becomes possible to lower the normal frequency of status monitoring. Thus, it becomes possible to lower the normal load on the server to be monitored 2.

Further, it becomes possible to securely acquire log information that is necessary for the investigation of the cause by setting the frequency of log acquisition high after the detection of an abnormality.

According to the device monitoring system as described above, it becomes possible to achieve flexible device monitoring so as to meet the status of an object to be monitored on the basis of the monitoring frequency definition that can be configured as desired.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A device monitoring system comprising:
a memory that stores a status of a plurality of monitoring items for each device to be monitored; and
a processor that detects a change in the status of monitoring items stored in the memory, and to define a status monitoring frequency of acquisition of the status of monitoring items from the device to be monitored, according to the detected change in status, and acquires the status of monitoring items from the device to be monitored according to the status monitoring frequency, and to store the acquired status of the monitoring items.

2. A device monitoring system comprising:
a memory that stores a status of a plurality of monitoring items for each device to be monitored, and a log in which an operation of the device to be monitored is recorded; and
a processor that detects a change in the status of monitoring items stored in the status information storage unit, and to define a log monitoring frequency of acquisition of a log from the device to be monitored according to the detected change in status, and acquires a log from the device to be monitored according to the log monitoring frequency, and to store the acquired log in the memory.

3. The device monitoring system according to claim 1, wherein
the processor changes the status monitoring frequency of acquisition of the status of monitoring items in which a change in status has occurred and changes related monitoring items according to the detected change in status.

4. The device monitoring system according to claim 1, wherein
the processor changes the status monitoring frequency for a device to be monitored in which a change in status has occurred and for a related device to be monitored, according to the detected change in status.

5. The device monitoring system according to claim 2, wherein
the processor changes the log monitoring frequency for a device to be monitored in which a change in status has occurred and for a related device to be monitored, according to the detected change in status.

6. A device monitoring method comprising:
referring to, by using a computer, a status information storage unit in which a status of a plurality of monitoring items is stored for each device to be monitored, and detecting a change in status of the monitoring items;
defining, by using a computer, a status monitoring frequency of acquisition of the status of monitoring items from the device to be monitored, according to the detected change in status; and
acquiring, by using a computer, the status of monitoring items from the device to be monitored according to the status monitoring frequency, and storing the acquired status of monitoring items in the status information storage unit.

7. A device monitoring method comprising:
referring to, by using a computer, a status information storage unit configured to store a status of a plurality of monitoring items for each device to be monitored, and detecting a change in status of the monitoring items;
defining, by using a computer, a log monitoring frequency of acquisition of a log in which an operation of the device to be monitored is stored from the device to be monitored, according to the detected change in status; and
acquiring, by using a computer, the log from the device to be monitored according to the log monitoring frequency, and storing the acquired log in a log information storage unit.

8. A computer-readable recording medium having stored therein a program for causing a computer to execute a process for monitoring a device, the process comprising:
referring to a status information storage unit in which a status of a plurality of monitoring items is stored for each device to be monitored, and detecting a change in status of the monitoring items;
defining a status monitoring frequency of acquisition of the status of monitoring items from the device to be monitored, according to the detected change in status; and
acquiring the status of monitoring items from the device to be monitored according to the status monitoring frequency, and storing the acquired status of monitoring items in the status information storage unit.

9. A computer-readable recording medium having stored therein a program for causing a computer to execute a process for monitoring a device, the process comprising:
referring to a status information storage unit configured to store a status of a plurality of monitoring items for each device to be monitored, and detecting a change in status of the monitoring items;
defining a log monitoring frequency of acquisition of a log in which an operation of the device to be monitored is stored from the device to be monitored, according to the detected change in status; and
acquiring the log from the device to be monitored according to the log monitoring frequency, and storing the acquired log in a log information storage unit.
